(19) United States
(12) Patent Application Publication
(10) Pub. No.: US 2022/0253637 A1
(43) Pub. Date: Aug. 11, 2022

(54) PATCH GENERATION IN REGION OF INTEREST

(71) Applicant: International Business Machines Corporation, Armonk, NY (US)

(72) Inventors: Amin Katouzian, Lexington, MA (US); Benedikt Graf, Charlestown, MA (US); Yusuke Takeuchi, Boston, MA (US)

(21) Appl. No.: 17/173,635

(22) Filed: Feb. 11, 2021

(51) Int. Cl. G06K 9/32; G06K 9/62; G06K 9/46

(52) U.S. Cl. CPC G06K 9/3233; G06K 9/4604; G06K 9/6202

(57) ABSTRACT

In a method for capturing patches in an image, a processor receives an image comprising a region of interest. A processor captures a first patch pattern. The first patch pattern may include a first point-centered patch that is centered on a first center point inside the region of interest and a first point-edged patch that is located with a patch edge contacting the first center point. A processor selects a second center point that is inside the region of interest and outside the first patch pattern. A processor captures a second patch pattern. The second patch pattern may include a second point-centered patch that is centered on the second center point, and a second point-edged patch that is located with a patch edge contacting the second center point.

### BACKGROUND OF THE INVENTION

The present invention relates generally to the field of object detection in digital images, and more particularly to generating patches in a region of interest within the digital images.

Computer vision tasks such as object detection and recognition, action recognition, texture classification, data retrieval, tracking, image alignment, etc., are usually performed using global or local image properties. Images are often represented using dense photometric pixel-based properties or by compact region descriptors often used with interest point detectors. Dense properties include raw pixel intensity or color values of the entire image, or of smaller patches. The basic use of patches for texture synthesis includes stitching together patches of the input texture, such that their boundaries overlap. This results in a new texture image, which matches the original texture in appearance, and has similar statistical properties. The success of the patch-based methods has been extended to image completion and to image denoising. Patch-based methods can also be successful in object recognition.

### SUMMARY

Aspects of an embodiment of the present invention disclose a method, computer program product, and computing system to capture patches in an image. A processor receives an image comprising a region of interest. A processor captures a first patch pattern. The first patch pattern may include a first point-centered patch that is centered on a first center point inside the region of interest and a first point-edged patch that is located with a patch edge contacting the first center point. A processor selects a second center point that is inside the region of interest and outside the first patch pattern. A processor captures a second patch pattern. The second patch pattern may include a second point-centered patch that is centered on the second center point, and a second point-edged patch that is located with a patch edge contacting the second center point.

### BRIEF DESCRIPTION OF THE DRAWINGS

FIG. 1 depicts a diagram of an image assessment system in accordance with one embodiment of the present invention;

FIG. 2 depicts a flowchart of the steps of the patch generation program executing within the system of FIG. 1, in accordance with an embodiment of the present invention; and

FIG. 3 depicts a binary mask that has a region of interest, in accordance with one embodiment of the present invention;

FIG. 4 depicts a grayscale image of a rib x-ray that has a region of interest, in accordance with one embodiment of the present invention;

FIGS. 5A-5H depict patches of a patch pattern, in accordance with one embodiment of the present invention;

FIG. 6 depicts a region of interest with potential center points that may be selected by the patch generation program for new patch patterns, in accordance with one embodiment of the present invention; and

FIG. 7 depicts a block diagram of components of one or more of the image database, the image segmentation device, the patch generation device, and the feature verification device in accordance with an illustrative embodiment of the present invention.

### DETAILED DESCRIPTION

The disclosed embodiments include devices and methods for capturing patches. And, more specifically, for capturing patch patterns that include multiple patches to increase the likelihood of accurate object detection within a region of interest of an image. As described in the background, patch are parts of an image that may be used to verify results of image detectors, such as segmentation models. The image detectors generate the region of interest, and patches may be used to confirm identification or presence of some detected object within the region of interest. The patches may be captured in a pattern centered within the region of interest, as described below, with additional patterns being captured at center points outside the original pattern.

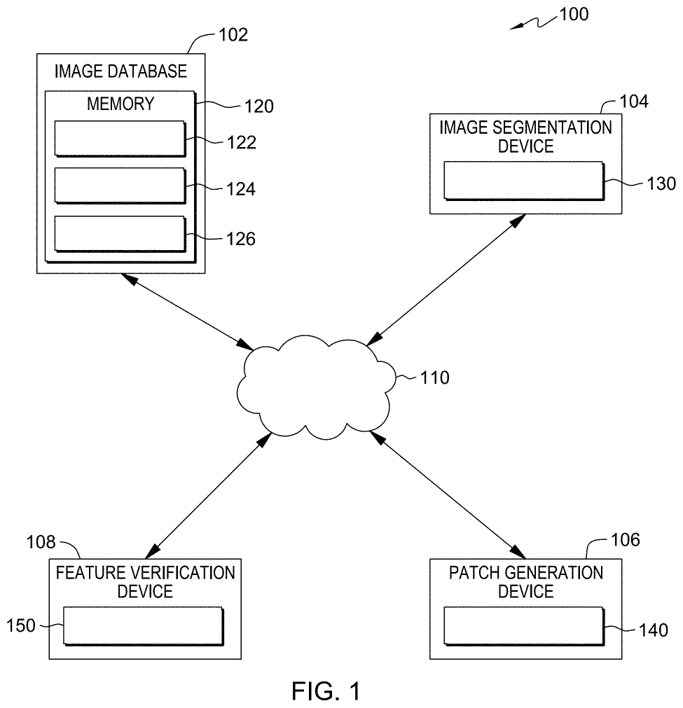

Turning now to the drawings, FIG. 1 depicts a diagram of an image assessment system 100 in accordance with one embodiment of the present invention. FIG. 1 provides only an illustration of one embodiment and does not imply any limitations with regard to the environments in which different embodiments may be implemented.

The system 100 includes an image database 102, an image segmentation device 104, a patch generation device 106, and a feature verification device 108. In certain embodiments, as illustrated, the image database 102, the image segmentation device 104, the patch generation device 106, and the feature verification device 108 are communicatively coupled via a communication network 110. The communication network 110 may be a local area network (LAN), a wide area network (WAN) such as the Internet, any combination thereof, or any combination of connections and protocols that will support communications between the image database 102, the image segmentation device 104, the patch generation device 106, and the feature verification device 108 in accordance with embodiments of the invention. The communication network 110 may include wired, wireless, or fiber optic connections. In certain embodiments, the image database 102, the image segmentation device 104, the patch generation device 106, and the feature verification device 108 may communicate without requiring the communication network 110, instead communicating via one or more dedicated wire connection or other forms of wired and wireless electronic communication.

The image database 102 includes a memory 120 for storing digital information. The memory 120 may include read-only memory (“ROM”), random access memory (“RAM”) (e.g., dynamic RAM (“DRAM”), synchronous DRAM (“SDRAM”), and the like), electrically erasable programmable read-only memory (“EEPROM”), flash memory, a hard disk, a secure digital (“SD”) card, other suitable memory devices, or a combination thereof. The memory includes, among other potential storage items, images 122 that may be viewed, evaluated, or otherwise operated upon by the image database 102, the image segmentation device 104, the patch generation device 106, and the feature verification device 108. For example, the images 122 may be accessed, through the communication network 110, by the image segmentation device 104.

The image segmentation device 104 runs a segmentor/segmentation program 130 (e.g., U-net) that partitions the image 122 into multiple segments (sets of pixels, also known as image objects). The segmentation program 130 segments the images 122 into segmented images 124 that may also be stored on the image database 102. The segmented images 124 include information that is more meaningful and easier to for computers to analyze. For example, the segmented images 124 may include segmentation heatmap images, binary masks, and gray-scale images that can be used to locate objects and boundaries (lines, curves, etc.) in the images 122. More precisely, the segmentation program 130 labels pixel in the images 122 such that pixels with the same label share certain characteristics. The segmented images 124, therefore, include segments, or a set of contours, superimposed over the features of the corresponding original image 122. Each of the pixels in a segment are similar with respect to some characteristic or computed property, such as color, intensity, or texture. Adjacent regions are different with respect to the same characteristics. When applied to a set of images 122 taken along a line (e.g., in medical imaging), the resulting contours of the segmented images 124 can be used to create 3D reconstructions.

The feature verification device 108 includes a verification program 150 that may use the segments/contours of the segmented images 124 to identify “objects” within the segmented images 124. Objects may include any feature or item within the images 122 or the segmented images 124 that may be uniquely identified. For example, the verification program 150 may identify actual objects, such as cars or people using the segmented images 124. Additionally or alternatively, the verification program 150 may identify a particular shape, size, or configuration of color (i.e., grayscale) or shading within an x-ray image as indicating a fracture. Identification based solely on the segmented images 124 can produce false positives, however. To confirm identification of an object, the verification program 150 may increase accuracy by using patches rather than the entire segmented image 124. The system 100, therefore, includes the patch generation device 106 that runs a patch generation program 140 captures patches 126 from the images 122 or the segmented images 124.

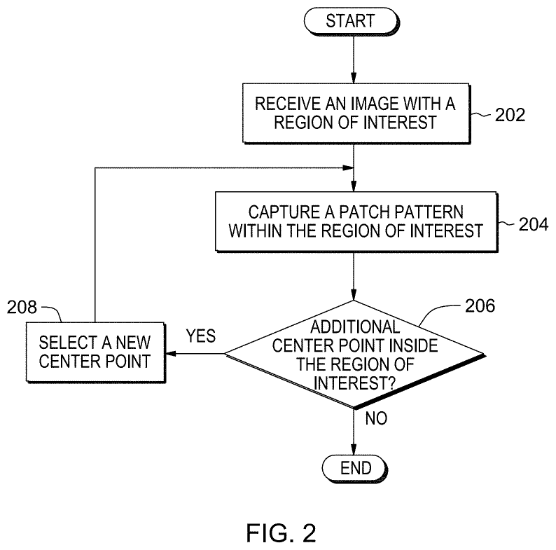

FIG. 2 depicts a flowchart of the steps of the patch generation program 140 executing within the system of FIG. 1, in accordance with an embodiment of the present invention. The patch generation program 140 receives one or more images (e.g., images 122 or segmented images 124) that have a region of interest (block 202). The region of interest may be a highlighted portion of a binary mask, or an identified segment within a gray-scale segmented image 124, among other things.

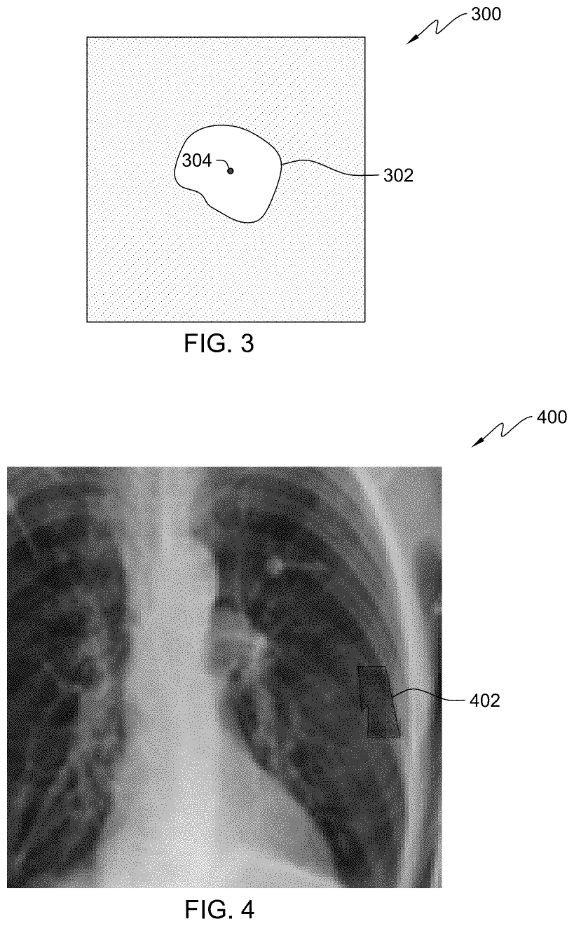

FIG. 3 depicts a binary mask 300 that has a region of interest 302, in accordance with one embodiment of the present invention. The binary mask 300 may be received by the patch generation program 140 for patch generation. The patch generation program 140 generates patches 126 that would be applied to the pixels of the underlying image beneath the binary mask 300. The region of interest 302 includes a centroid 304 that may be identified by the patch generation program 140, the segmentation program 130, manually, or by another program.

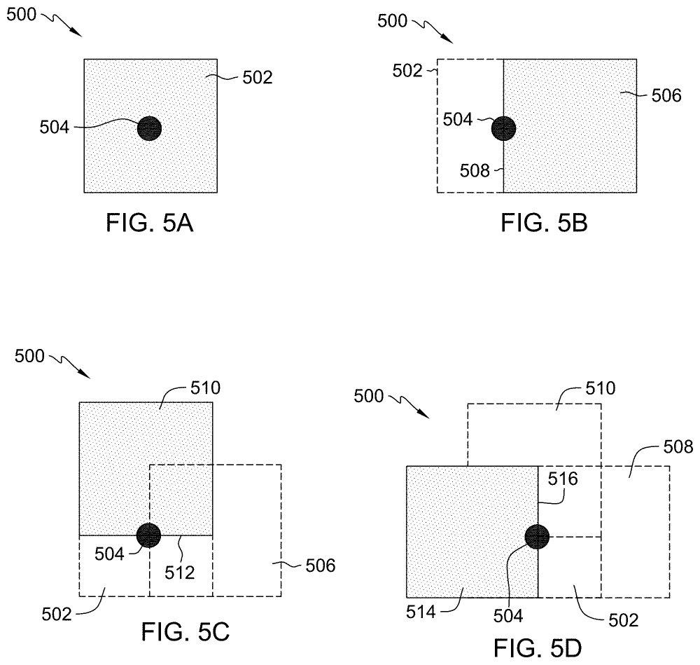

In another example of an image that may be received by the patch generation program 140, FIG. 4 depicts a grayscale image 400 of a rib x-ray that has a region of interest 402, in accordance with one embodiment of the present invention. The region of interest 402 may be an area of the grayscale image 400 that the segmentation program 130 has identified as a rib fracture.

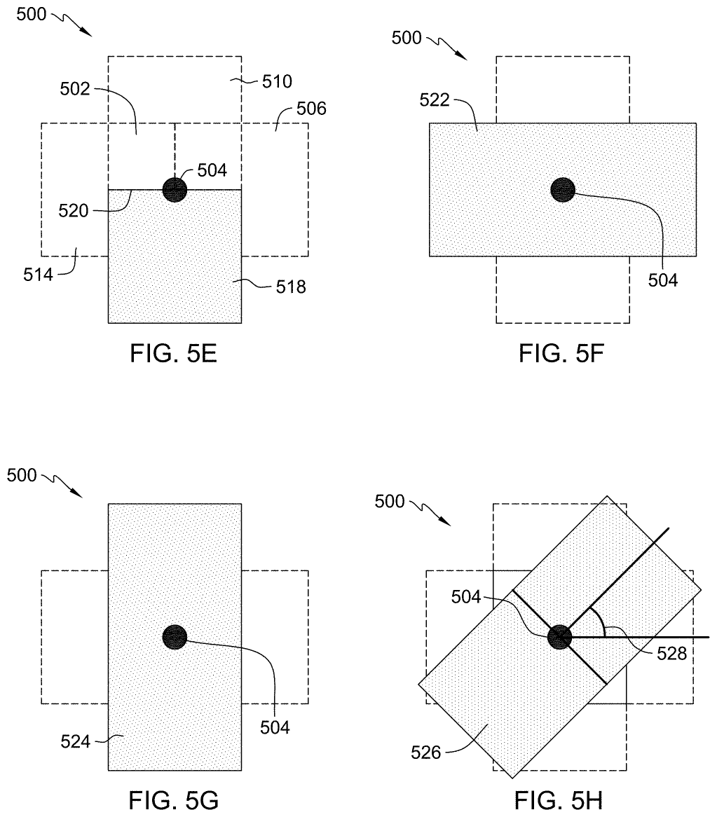

Once the images are received, the patch generation program 140 captures a patch pattern (block 204). The patch pattern may include patches (e.g., the patches 126 of FIG. 1) located with reference to a center point. For example, the patch pattern may include point-centered patches and point-edged patches. The point-centered patches are centered on a center point, while the point-edged patches are located with a patch edge contacting the center point. The patch pattern may collected as a series (for example, the series shown in FIGS. 5A-5G), that may be repeated for many center points selected within the region of interest.

FIG. 5A depicts a first point-centered patch 502 of a patch pattern 500, in accordance with one embodiment of the present invention. The first point-centered patch 502 is centered on a first center point 504. The first center point 504 may be the centroid (e.g., the centroid 304 of FIG. 3) of the region of interest. The centroid of the region of interest may be selected as a natural initiation point, but the first center point 504 may be located anywhere within the region of interest. The first point-centered patch 502 is illustrated as a square, but other shapes may be used to capture patches as well. The size of the first point-centered patch 502 may also change, depending on the limitations or capabilities of the system 100. For example, the first point-centered patch 502 may have a width and height of 4 pixels, 10 pixels, 20 pixels, or more.

FIG. 5B depicts a first point-edged patch 506 of the patch pattern 500, in accordance with one embodiment of the present invention. The first point-edged patch 506 is located with a patch edge contacting the first center point 504. Specifically, the first point-edged patch 506 is located with a left edge 508 contacting the first center point 504. The first point-edged patch 506 has the left edge 508 centered on the first center point 504, but in certain embodiments the left edge 508 may contact the first center point 504 at a different part of the left edge 508. The patch generation program 140 captures each additional patch (e.g., first point-edged patch 506), and may track the locations of captured patches (i.e., the dotted box of the first point-centered patch 502).

FIG. 5C depicts a second point-edged patch 510 of the patch pattern 500, in accordance with one embodiment of the present invention. The second point-edged patch 510 is also located with a patch edge contacting the first center point 504. Specifically, the second point-edged patch 510 is located with a bottom edge 512 contacting the first center point 504.

FIG. 5D depicts a third point-edged patch 514 of the patch pattern 500, in accordance with one embodiment of the present invention. The third point-edged patch 510 is also located with a patch edge contacting the first center point 504. Specifically, the third point-edged patch 514 is located with a right edge 516 contacting the first center point 504.

FIG. 5E depicts a fourth point-edged patch 518 of the patch pattern 500, in accordance with one embodiment of the present invention. The fourth point-edged patch 518 is also located with a patch edge contacting the first center point 504. Specifically, the fourth point-edged patch 518 is located with a top edge 520 contacting the first center point 504. The patch generation program 140 may customize the number of patches captured in a patch pattern, and may stop with the four patches (i.e., first point-centered patch 502, first point-edged patch 506, second point-edged patch 510, third point-edged patch 514, and fourth point-edged patch 518) shown in FIG. 5E. In certain embodiments, on the other hand, the patch generation program 140 may generate dozens of patches based on the first center point 504.

FIG. 5F depicts a second point-centered patch 522 of the patch pattern 500, in accordance with one embodiment of the present invention. The second point-centered patch 522 is centered on the first center point 504, but has a rectangular shape rather than a square shape like the patches described above. Any size of rectangle may be captured by the patch generation program 140, but the second point-centered patch 522 is a combination of the first point-edged patch 506 and the third point-edged patch 514. The rectangular shape of the second point-centered patch 522 may enable the verification program 150 to better identify objects that are not wholly contained within the first point-edged patch 506 or the third point-edged patch 514. Specifically, if the patch pattern is being taken to identify a rib fracture, but the rib fracture crosses the boundary between the first point-edged patch 506 and the third point-edged patch 514, then neither the first point-edged patch 506 nor the third point-edged patch 514 will have a high likelihood of enabling the verification program 150 to identify the rib fracture. The second point-centered patch 522, however, has a high likelihood of enabling the verification program 150 to identify the rib fracture since the entire rib fracture is present within the second point-centered patch 522. A similar benefit may be provided by combining the second point-edged patch 510 and the fourth point-edged patch 518 into the rectangular third point-centered patch 524 shown in FIG. 5G.

Another benefit of capturing patches within a patch pattern associated with a center point is illustrated in FIG. 5H. FIG. 5H depicts a fourth point-centered patch 526 of the patch pattern 500, in accordance with one embodiment of the present invention. The fourth point-centered patch 526 is captured at a rotated angle 528 relative to the grid structure of the pixels in the image. While the fourth point-centered patch 526 is captured at the rotated angle 528, but may be evaluated by the verification program 150 in the more customary orientation. The rotated orientation of the fourth point-centered patch 526 enables the verification program 150 to detect objects that can sometimes be misidentified or overlooked due to being aligned with horizontal or vertical axes of the image. The rotated angle 528 in FIG. 5H is approximately 45 degrees, but the patch generation program 140 may capture patches at any angle. For example, in certain embodiments, the patch generation program 140 may capture 90 patches: at every angle between 1 degrees and 90 degrees.

Once the patch generation program 140 has captured a patch pattern, the patch generation program 140 determines whether there is an additional center point inside the region of interest (block 206). To do so, the patch generation program 140 may generate potential center points, or may evaluate a grid of potential center points. If there are additional center points inside the region of interest (block 206 “Yes”), then the patch generation program 140 selects a new center point (block 208) and captures a new patch pattern (re-operation of block 204).

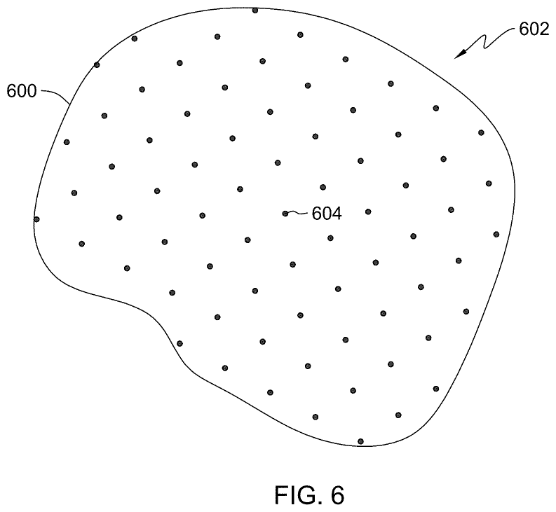

FIG. 6A depicts a region of interest 600 with a grid of potential center points 602 that may be selected by the patch generation program 140 for new patch patterns, in accordance with one embodiment of the present invention. The potential center points 602 in the illustrated embodiment are laid out in a grid pattern with even spacing between the potential center points 602, but the potential center points 602 in other embodiments may have different spacing that is uneven or random (i.e., without a grid pattern). The patch generation program 140 may begin capturing patch patterns by selecting a centroid 604 as the first center point. The patch generation program 140 may also select a top-right, top-left, or other potential center point 602 as the first center point. The patch generation program 140 then progresses over the region of interest 600, capturing a patch pattern using each potential center points 602 as the center point of the patch pattern, as described above. When there are no potential center points 602 left from which to capture a patch pattern (block 206 “No”), the patch generation program 140 terminates.

FIG. 6B depicts a portion of the region of interest 600 of FIG. 6A, in accordance with an embodiment of the present invention. In the embodiment depicted in FIG. 6B, a first patch pattern 606 is captured at the centroid 604. The first patch pattern 606 may include any number of patches, as described in detail above. When the first patch pattern 606 is fully captured, the patch generation program 140 selects a location for a potential center point 602 and determines whether the potential center point 602 is inside the region of interest 600. That is, rather than rely on preselected potential center points 602, such as the grid pattern depicted in the embodiment of FIG. 6A, the patch generation program 140 finds new locations for potential center points 602 after each patch pattern is captured. To determine whether the potential center point 602 is inside the region of interest 600, the patch generation program 140 may evaluate values at the potential center point 602 and compare the values to criteria indicating whether the potential center point 602 is within the region of interest 600.

For example, the patch generation program 140 may compare a pixel grayscale value to a grayscale threshold. If the pixel grayscale value is within the threshold, the patch generation program 140 will capture a second patch pattern 608 around the potential center point 602. If the pixel grayscale value is not within the threshold, the patch generation program 140 determines that the potential center point 602 is not within the region of interest 600, and does not capture a patch pattern. The patch generation program 140 would proceed to select a new pixel/point to compare against the criteria until there is a pixel grayscale value that is within the threshold. When there are no more potential center points that are within the criteria for capturing patch patterns (i.e., there are no more potential center points located within the region of interest 600), the patch generation program 140 terminates.

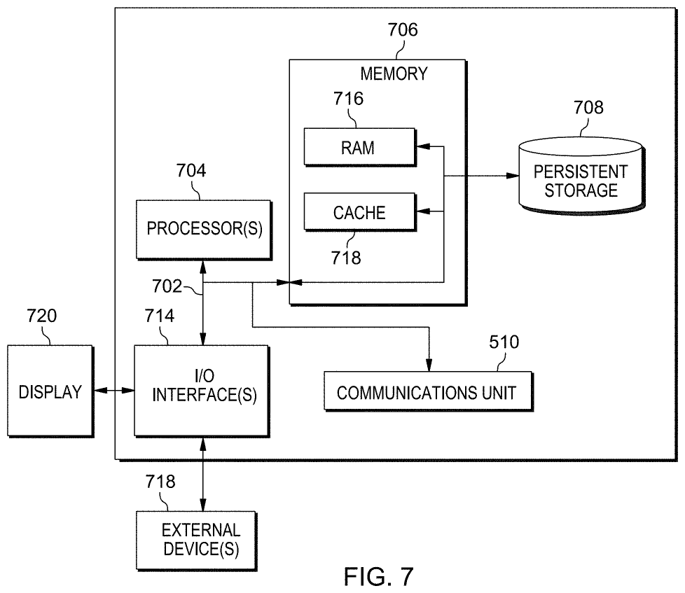

FIG. 7 depicts a block diagram of components of one or more of the image database 102, the image segmentation device 104, the patch generation device 106, and the feature verification device 108 in accordance with an illustrative embodiment of the present invention. Each of the image database 102, the image segmentation device 104, the patch generation device 106, and the feature verification device 108 may be embodied on a separate device, or each of the image database 102, the image segmentation device 104, the patch generation device 106, and the feature verification device 108 may be embodied on the same device having the components shown in FIG. 7. It should be appreciated that FIG. 7 provides only an illustration of one implementation and does not imply any limitations with regard to the environments in which different embodiments may be implemented. Many modifications to the depicted environment may be made.

The image database 102, the image segmentation device 104, the patch generation device 106, and/or the feature verification device 108 may include communications fabric 702, which provides communications between RAM 714, cache 716, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses or a crossbar switch.

Memory 706 and persistent storage 708 are computer readable storage media. In this embodiment, memory 706 includes random access memory (RAM). In general, memory 706 can include any suitable volatile or non-volatile computer readable storage media. Cache 716 is a fast memory that enhances the performance of computer processor(s) 704 by holding recently accessed data, and data near accessed data, from memory 706.

The segmentation program 130, the patch generation program 140, and the verification program 150 may be stored in persistent storage 708 and in memory 706 for execution and/or access by one or more of the respective computer processors 704 via cache 716. In an embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer readable storage medium that is also part of persistent storage 708.

Communications unit 710, in these examples, provides for communications with other data processing systems or devices. In these examples, communications unit 710 includes one or more network interface cards. Communications unit 710 may provide communications through the use of either or both physical and wireless communications links. The segmentation program 130, the patch generation program 140, and the verification program 150 may be downloaded to persistent storage 708 through communications unit 710.

I/O interface(s) 712 allows for input and output of data with other devices that may be connected to server computer. For example, I/O interface 712 may provide a connection to external devices 718 such as a keyboard, keypad, a touch screen, and/or some other suitable input device. External devices 718 can also include portable computer readable storage media such as, for example, thumb drives, portable optical or magnetic disks, and memory cards. Software and data used to practice embodiments of the present invention (e.g., the segmentation program 130, the patch generation program 140, and the verification program 150) can be stored on such portable computer readable storage media and can be loaded onto persistent storage 708 via I/O interface(s) 712. I/O interface(s) 712 also connect to a display 720.

Display 720 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for capturing patches, comprising:
receiving, at a processor, an image comprising a region of interest;
capturing a first patch pattern, wherein the first patch pattern comprises:
a first point-centered patch that is centered on a first center point inside the region of interest; and
a first point-edged patch that is located with a patch edge contacting the first center point;
selecting a second center point that is inside the region of interest and outside the first patch pattern; and
capturing a second patch pattern, wherein the second patch pattern comprises:
a second point-centered patch that is centered on the second center point; and
a second point-edged patch that is located with a patch edge contacting the second center point.

2. The method of claim 1, wherein the first patch pattern comprises a second point-centered patch that is rotated at an angle relative to the first point-centered patch, wherein the angle is greater than 0 degrees and less than 90 degrees.

3. The method of claim 1, wherein the first point-edged patch comprises a selection from the group consisting of: a patch with a left edge contacting the first center point, a patch with a right edge contacting the first center point, a patch with a bottom edge contacting the first center point, and a patch with a top edge contacting the first center point.

4. The method of claim 1, wherein the first patch pattern comprises a patch with a left edge contacting the first center point, a patch with a right edge contacting the first center point, a patch with a bottom edge contacting the first center point, and a patch with a top edge contacting the first center point.

5. The method of claim 1, wherein the first center point comprises a centroid of the region of interest.

6. The method of claim 1, wherein selecting the second center point comprises comparing a pixel grayscale value to a grayscale threshold.

7. The method of claim 1, wherein the image comprises a selection from the group consisting of: a segmentation heatmap image, a binary mask, and a gray-scale image.

8. A computer program product for capturing patches in an image, the computer program product comprising:
one or more computer-readable storage media and program instructions stored on the one or more computer-readable storage media, the program instructions comprising:
program instructions to receive, at a processor, an image comprising a region of interest;
program instructions to capture a first patch pattern, wherein the first patch pattern comprises:
a first point-centered patch that is centered on a first center point inside the region of interest; and
a first point-edged patch that is located with a patch edge contacting the first center point;
program instructions to select a second center point that is inside the region of interest and outside the first patch pattern; and
program instructions to capture a second patch pattern, wherein the second patch pattern comprises:
a second point-centered patch that is centered on the second center point; and
a second point-edged patch that is located with a patch edge contacting the second center point.

9. The computer program product of claim 8, wherein the first patch pattern comprises a second point-centered patch that is rotated at an angle relative to the first point-centered patch, wherein the angle is greater than 0 degrees and less than 90 degrees.

10. The computer program product of claim 8, wherein the first point-edged patch comprises a selection from the group consisting of: a patch with a left edge contacting the first center point, a patch with a right edge contacting the first center point, a patch with a bottom edge contacting the first center point, and a patch with a top edge contacting the first center point.

11. The computer program product of claim 8, wherein the first patch pattern comprises a patch with a left edge contacting the first center point, a patch with a right edge contacting the first center point, a patch with a bottom edge contacting the first center point, and a patch with a top edge contacting the first center point.

12. The computer program product of claim 8, wherein the first center point comprises a centroid of the region of interest.

13. The computer program product of claim 8, wherein selecting the second center point comprises comparing a pixel grayscale value to a grayscale threshold.

14. The computer program product of claim 8, wherein the image comprises a selection from the group consisting of a segmentation heatmap image, a binary mask, and a gray-scale image.

15. A computer system for capturing patches in an image, the computer system comprising:
one or more computer processors, one or more computer-readable storage media, and program instructions stored on the computer-readable storage media for execution by at least one of the one or more processors, the program instructions comprising:
program instructions to receive, at a processor, an image comprising a region of interest;
program instructions to capture a first patch pattern, wherein the first patch pattern comprises:
a first point-centered patch that is centered on a first center point inside the region of interest; and
a first point-edged patch that is located with a patch edge contacting the first center point;
program instructions to select a second center point that is inside the region of interest and outside the first patch pattern; and
program instructions to capture a second patch pattern, wherein the second patch pattern comprises:
a second point-centered patch that is centered on the second center point; and
a second point-edged patch that is located with a patch edge contacting the second center point.

16. The system of claim 15, wherein the first patch pattern comprises a second point-centered patch that is rotated at an angle relative to the first point-centered patch, wherein the angle is greater than 0 degrees and less than 90 degrees.

17. The system of claim 15, wherein the first point-edged patch comprises a selection from the group consisting of: a patch with a left edge contacting the first center point, a patch with a right edge contacting the first center point, a patch with a bottom edge contacting the first center point, and a patch with a top edge contacting the first center point.

18. The system of claim 15, wherein the first patch pattern comprises a patch with a left edge contacting the first center point, a patch with a right edge contacting the first center point, a patch with a bottom edge contacting the first center point, and a patch with a top edge contacting the first center point.

19. The system of claim 15, wherein the first center point comprises a centroid of the region of interest.

20. The system of claim 15, wherein selecting the second center point comprises comparing a pixel grayscale value to a grayscale threshold.
